(19) United States
(12) Patent Application Publication
(10) Pub. No.: US 2022/0308676 A1
(43) Pub. Date: Sep. 29, 2022

(54) ROTATION-BASED ACTIONS ON COMPUTING DEVICES

(71) Applicant: Hewlett-Packard Development Company, L.P., Spring, TX (US)

(72) Inventors: Xinwei Zhang, Fort Collins, CO (US); Zachary Tahenakos, Fort Collins, CO (US); Daryl T. Poe, Fort Collins, CO (US)

(73) Assignee: Hewlett-Packard Development Company, L.P., Spring, TX (US)

(21) Appl. No.: 17/615,602

(22) PCT Filed: Sep. 27, 2019
(86) PCT No.: PCT/US2019/053484

§ 371 Date: Dec. 1, 2021

(51) Int. Cl. G06F 3/03; G06F 1/16

(52) U.S. Cl. CPC G06F 3/03; G06F 1/1616

(57) ABSTRACT

An example computing device includes a base member, a display member rotatably connected to the base member, and a processor to detect a rotation of the display member to an angle with respect to the base member, detect a speed at which the display member is rotated to the angle, and, based on the speed, perform an action on the computing device upon the display member reaching the angle with respect to the base member.

### BACKGROUND

The emergence and popularity of mobile computing has made portable computing devices, due to their compact design and light weight, a staple in today's marketplace. Within the mobile computing realm, notebook computers, or laptops, are one of the more widely used devices and generally employ a clamshell-type design consisting of two housings connected together at a common end via hinges, for example. In most cases, a first housing or display member is utilized to provide a viewable display to a user while a second housing or base member includes an area for user input (e.g., touchpad and keyboard). In addition, the viewable display may be a touchscreen (e.g., touchscreen laptop), allowing the user to interact directly with what is displayed by touching the screen with simple or multi-touch gestures.

### BRIEF DESCRIPTION OF THE DRAWINGS

FIG. 1 illustrates a computing device, such as a notebook computer, for performing various actions, based on a rotation of a display member with respect to a base member, according to an example;

FIG. 2 illustrates a method, for example, at a computing device, for performing various actions, based on a rotation of a display member with respect to a base member, according to an example; and

FIG. 3 is a flow diagram in accordance with an example of the present disclosure.

### DETAILED DESCRIPTION

Examples disclosed herein provide the ability to perform various actions on a computing device, such as the notebook computer described above, based on a rotation of a first housing of the computing device (e.g., display member) with respect to a second housing of the computing device (e.g., base member), according to an example. Rather than relying solely on preconfigured positions, such as a fully closed or fully open position, to perform an action on a computing device, such as switching between sleep and awake power states, other actions may be performed as well, for example, while the display member of the notebook computer is at angles between the fully closed and open positions. As will be further described, a speed or acceleration at which the display member is rotated with respect to the base member may be taken into consideration when deciding which operations to perform. As a result, although the display member may be rotated to a particular angle with respect to the base member, the speed and/or acceleration at which the display member is rotated to the particular angle may determine which action should be performed.

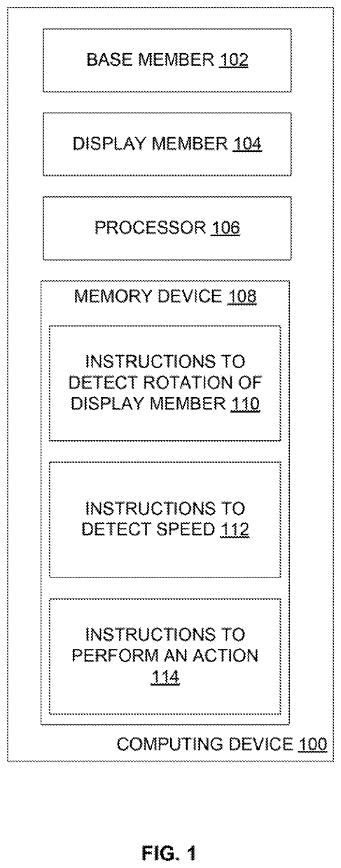

With reference to the figures, FIG. 1 illustrates a computing device 100, such as a notebook computer, for performing various actions, based on a rotation of a display member 104 with respect to a base member 102, according to an example. As described above, notebook computers generally employ a clamshell-type design consisting of two housings connected together at a common end via hinges, for example. As an example, a first housing or display member 104 is utilized to provide a viewable display to a user while a second housing or base member 102 includes an area for user input (e.g., touchpad and keyboard). As will be further described, when the display member 104 is rotated to a particular angle with respect to the base member 102, a speed or acceleration at which the display member 104 is rotated with respect to the base member 102 may be taken into consideration when deciding which actions to perform.

The computing device 100 depicts a processor 106 and a memory device 108 and, as an example of the computing device 100 performing its operations, the memory device 108 may include instructions 110-114 that are executable by the processor 106. Thus, memory device 108 can be said to store program instructions that, when executed by processor 106, implement the components of the computing device 100. The executable program instructions stored in the memory device 108 include, as an example, instructions to detect rotation of display member 104 (110), instructions to detect speed (112), and instructions to perform an action (114).

Instructions to detect rotation of display member 104 (110) represent program instructions that when executed by the processor 106 cause the computing device 100 to detect a rotation of the display member 104 to an angle with respect to the base member 102. As an example, a sensor may measure the angle at which the display member 104 is rotated with respect to the base member 102. Examples of sensors include, but are not limited to, a hall sensor or a rotary encoder, for example, installed on the hinge coupling the display member 104 to the base member 102, in combination with an accelerometer. A rotary encoder, also called a shaft encoder, may refer to an electro-mechanical device that converts the angular position or motion of a shaft or axle to analog or digital output signals, which can provide the angle of the display member 104 with respect to the base member 102. As an example, the angle of the display member 104 with respect to the base member 102 may be reported in a numerical form between some minimum and maximum value, for example, limited by the physical configuration of the computing device 100. For example, certain notebook computers may open to 120 degrees, while others may open fully to 360 degrees (e.g., convertible notebooks). As a result, the sensor may report the position of the display member 104 between 0 degrees when fully closed and either 120 degrees or 360 degrees, based on the physical configuration of the computing device 100.

As an example, the position of the display member 104 with respect to the base member 102 may be continuously available through a registry location or poll-friendly system call. However, rather than being continuously available, the operating system (OS) may be notified when the position of the display member 104 is actively changing. Applications installed on the computing device 100 may choose to subscribe to such signals so that they do not have to continuously poll the position of the display member 104. With regards to speed and acceleration, which will be described further below, they be measured by the basic input/output system (BIOS) and provided to the OS. However, the OS may also monitor the position of the display member 104 and then derive the secondary characteristics of speed and acceleration.

Instructions to detect speed (112) represent program instructions that when executed by the processor 106 cause the computing device 100 to detect a first speed at which the display member 104 is rotated to the angle. As an example, in addition to determining the angle of the display member 104 with respect to the base member 102, the sensor described above may also measure the speed at which the display member 104 is rotated with respect to the base member 102. With regards to the numerical form that the angle is reported, as described above, the rate at which the numerical form changes while the display member 104 is rotated open to the angle may determine the speed at which the display member 104 is opened. Similarly, the acceleration at which the display member 104 is rotated open may be measured as well, for example, by measuring a change over time in a speed of rotation as the display member 104 is rotated to the angle with respect to the base member 102, as will be further described.

Instructions to perform an action (114) represent program instructions that when executed by the processor 106 cause the computing device 100, based on the first speed, to perform a first action on the computing device 100 upon the display member 104 reaching the angle with respect to the base member 102. Similarly, if a second speed different from the first speed is detected at which the display member 104 is rotated to the angle with respect to the base member 102, a second action different from the first action may be performed instead, upon the display member 104 reaching the angle with respect to the base member 102. As a result, although the display member 104 may be rotated to a particular angle with respect to the base member 102, the speed at which the display member 104 is rotated to the particular angle may determine which action should be performed, thereby allowing for various actions to be performed. Rather than relying on a particular speed or speed range at which the display member 104 is rotated, the computing device 100 may determine whether the speed at which the display member 104 is rotated is above or below a threshold value. For example, if the speed is less than the threshold value, a first action may be performed, and if the speed is greater than the threshold value, a second action different from the first action may be performed.

As an example, in addition to measuring the speed at which the display member 104 is rotated with respect to the base member 102, the acceleration may be measured as well, for example, by measuring a change over time in a speed of rotation as the display member 104 is rotated to the angle with respect to the base member 102. As a result, the computing device 100 may determine which action to perform when the display member 104 is rotated to an angle, based on a speed at which the display member 104 is rotated, its acceleration, or a combination thereof. As an example, if the display member 104 is rotated to a particular angle, the speed at which the display member 104 is rotated to the particular angle, or the acceleration at which the display member 104 is rotated, or even a combination of the speed and acceleration, may be relied upon to determine which action would be performed. Such parameters for determining which actions to perform may be predefined or user customizable.

As an example, if relying solely on acceleration, if a first acceleration is detected, a first action may be performed, and if a second acceleration is detected, a second action different from the first action may be performed. Rather than relying on a particular acceleration or acceleration range at which the display member 104 is rotated, the computing device 100 may determine whether the acceleration at which the display member 104 is rotated is above or below a threshold value. For example, if the acceleration is less than the threshold value, a first action may be performed, and if the acceleration is greater than the threshold value, a second action different from the first action may be performed.

Examples of the various actions that may be performed on the computing device 100, for example, to control its behavior, include, but are not limited to, adjusting the screen brightness of the display member 104, going to low power mode, going to sleep, hibernating, shutting down the computing device 100, locking disks, and switching modes. The list of actions that may be performed based on the speed and/or acceleration of the display member 104 as it rotated to an angle with respect to the base member 102 may be either predefined or customized by an end user of the computing device (i.e., user customizable). As described above, the actions may depend on the position and speed/acceleration of the display member 104, or some combination thereof. As a result, a wide variety of actions may be accommodated, thereby, providing the opportunity to deliver a customized user experience.

As an example, for backwards compatibility, for computing devices that solely perform actions at fully closed or fully open positions, the computing device 100 may send “opening” and “closing” signals when the display member 104 is fully opened or closed. However, with the sensor described above, it may be possible to program the position or angle at which the “opening” and “closing” signals are sent. As a result, one end user may prefer the “closing” signal be sent at a 20 degree angle while another may prefer the “closing” signal when the display member 104 has reached 45 degrees with respect to the base member, while it is being closed.

Memory device 108 represents generally any number of memory components capable of storing instructions that can be executed by processor 106. Memory device 108 is non-transitory in the sense that it does not encompass a transitory signal but instead is made up of at least one memory component configured to store the relevant instructions. As a result, the memory device 108 may be a non-transitory computer-readable storage medium. Memory device 108 may be implemented in a single device or distributed across devices. Likewise, processor 106 represents any number of processors capable of executing instructions stored by memory device 108. Processor 106 may be integrated in a single device or distributed across devices. Further, memory device 108 may be fully or partially integrated in the same device as processor 106, or it may be separate but accessible to that device and processor 106.

In one example, the program instructions 110-114 can be part of an installation package that when installed can be executed by processor 106 to implement the components of the computing device 100. In this case, memory device 108 may be a portable medium such as a CD, DVD, or flash drive or a memory maintained by a server from which the installation package can be downloaded and installed. In another example, the program instructions may be part of an application or applications already installed. Here, memory device 108 can include integrated memory such as a hard drive, solid state drive, or the like.

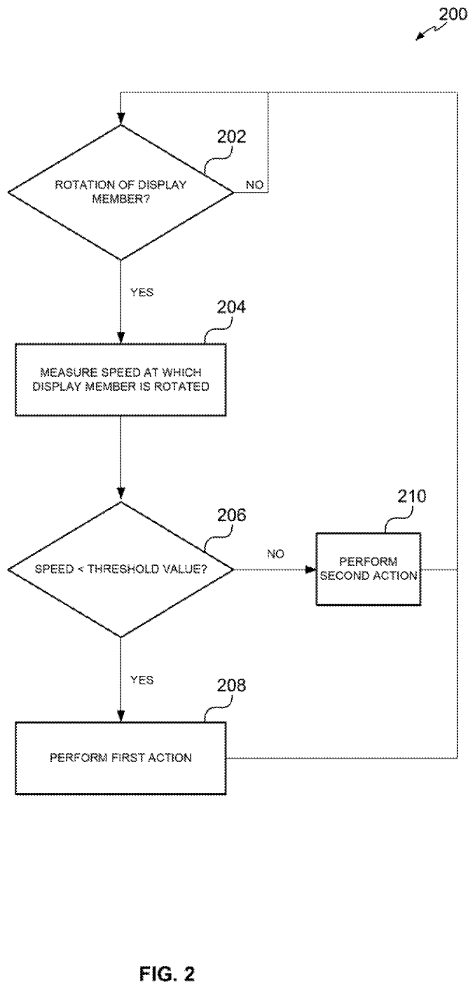

FIG. 2 illustrates a method 200, for example, at a computing device, for performing various actions, based on a rotation of a display member with respect to a base member, according to an example. In discussing FIG. 2, reference may be made to the example computing device 100 illustrated in FIG. 1. Such reference is made to provide contextual examples and not to limit the manner in which method 200 depicted by FIG. 2 may be implemented.

Method 200 begins at 202, where the computing device determines whether there is a rotation of the display member, for example, while the display member is rotated to an angle. As an example, a sensor, such as a hall sensor or rotary encoder, may determine whether there is a rotation of the display member. As described above, the position of the display member with respect to the base member may be continuously available through a registry location or poll-friendly system call. However, rather than being continuously available, the OS may be notified when the position of the display member is actively changing. If no rotation of the display member is detected, operations revert back to 202. However, if there is a rotation of the display member, operations proceed to 204.

At 204, the computing device measures a speed at which the display member is rotated to the angle. As an example, in addition to determining the angle of the display member with respect to the base member, the sensor described above may also measure the speed at which the display member is rotated with respect to the base member. At 206, the computing device determines whether the measured speed is less than a threshold value. As will be further described, at least two different actions may be performed when the display member is rotated to a particular angle, based on the speed at which the display member is rotated.

At 208, if the measured speed is less than the threshold value, the computing device performs a first action. However, at 210, if the speed is not less than the threshold value (e.g., greater than the threshold value), the computing device performs a second action that is different from the first action. Examples of the various actions that may be performed on the computing device, for example, to control its behavior, include, but are not limited to, adjusting the screen brightness of the display member, going to low power mode, going to sleep, hibernating, shutting down the computing device, locking disks, and switching modes.

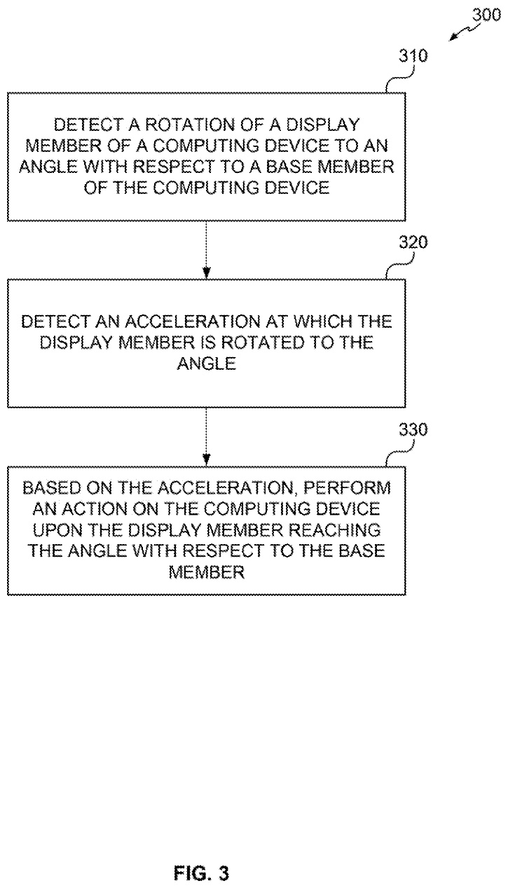

FIG. 3 is a flow diagram 300 of steps taken by a computing device to perform various actions, based on a rotation of a display member with respect to a base member, according to an example. Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

At 310, the computing device detects a rotation of a display member of the computing device to an angle with respect to a base member of the computing device. As an example, a sensor, such as a hall sensor or rotary encoder, may determine whether there is a rotation of the display member, and the angle to which the display member is rotated.

At 320, the computing device detects a first acceleration at which the display member is rotated to the angle. As an example, the computing device may determine the acceleration at which the display member is rotated by measuring a change over time in a speed of rotation as the display member is rotated to the angle with respect to the base member.

At 330, based on the first acceleration, the computing device performs a first action on the computing device upon the display member reaching the angle with respect to the base member. As an example, if the computing device detects a second acceleration at which the display member is rotated to the angle, the second acceleration different from the first acceleration, the computing device, based on the second acceleration, may then perform a second action on the computing device upon the display member reaching the angle with respect to the base member, the second action different from the first action. As a result, although the display member may be rotated to a particular angle with respect to the base member, the acceleration at which the display member is rotated to the particular angle may determine which action should be performed, thereby allowing for various actions to be performed.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A computing device comprising:
a base member;
a display member rotatably connected to the base member; and
a processor to:
detect a rotation of the display member to an angle with respect to the base member;
detect a first speed at which the display member is rotated to the angle; and
based on the first speed, perform a first action on the computing device upon the display member reaching the angle with respect to the base member.

2. The computing device of claim 1, wherein the processor is to:
detect a second speed at which the display member is rotated to the angle, wherein the second speed is different from the first speed; and
based on second speed, perform a second action on the computing device upon the display member reaching the angle with respect to the base member, wherein the second action is different from the first action.

3. The computing device of claim 2, wherein the first and second actions are user customizable.

4. The computing device of claim 1, wherein the processor is to:
measure an acceleration at which the display member is rotated to the angle;
if the acceleration is less than a threshold value, perform the first action on the computing device upon the display member reaching the angle with respect to the base member; and
if the acceleration is greater than the threshold value, perform a second action on the computing device upon the display member reaching the angle with respect to the base member, wherein the second action is different from the first action.

5. The computing device of claim 4, further comprising a sensor to measure the acceleration by measuring a change over time in a speed of rotation as the display member is rotated to the angle with respect to the base member.

6. The computing device of claim 5, wherein the sensor is to measure a speed and an angle at which the display member is rotated with respect to the base member.

7. A non-transitory computer-readable storage medium comprising program instructions which, when executed by a processor of a computing device, cause the processor to:
detect a rotation of a display member of the computing device to an angle with respect to a base member of the computing device;
measure a speed at which the display member is rotated to the angle;
if the speed is less than a threshold value, perform a first action on the computing device upon the display member reaching the angle with respect to the base member; and
if the speed is greater than the threshold value, perform a second action on the computing device upon the display member reaching the angle with respect to the base member, wherein the second action is different from the first action.

8. The non-transitory computer-readable storage medium of claim 7, wherein the first and second actions are user customizable.

9. The non-transitory computer-readable storage medium of claim 7, wherein the program instructions, when executed, further cause the processor to:
measure an acceleration at which the display member is rotated to the angle;
if the acceleration is less than a threshold value, perform the first action on the computing device upon the display member reaching the angle with respect to the base member; and
if the acceleration is greater than the threshold value, perform a second action on the computing device upon the display member reaching the angle with respect to the base member, wherein the second action is different from the first action.

10. The non-transitory computer-readable storage medium of claim 9, wherein the program instructions, when executed, further cause the processor to measure, via a sensor the acceleration by measuring a change over time in a speed of rotation as the display member is rotated to the angle with respect to the base member.

11. The non-transitory computer-readable storage medium of claim 10, wherein the sensor is to measure a speed and an angle at which the display member is rotated with respect to the base member.

12. A method comprising:
detecting a rotation of a display member of a computing device to an angle with respect to a base member of the computing device;
detecting a first acceleration at which the display member is rotated to the angle; and
based on the first acceleration, performing a first action on the computing device upon the display member reaching the angle with respect to the base member.

13. The method of claim 12, further comprising:
detecting a second acceleration at which the display member is rotated to the angle, wherein the second acceleration is different from the first acceleration; and
based on second acceleration, performing a second action on the computing device upon the display member reaching the angle with respect to the base member, wherein the second action is different from the first action.

14. The method of claim 12, further comprising:
measuring a speed at which the display member is rotated to the angle;
if the speed is less than a threshold value, perform the first action on the computing device upon the display member reaching the angle with respect to the base member; and
if the speed is greater than the threshold value, perform a second action on the computing device upon the display member reaching the angle with respect to the base member, wherein the second action is different from the first action.

15. The method of claim 12, further comprising measuring, via a sensor, the first acceleration by measuring a change over time in a speed of rotation as the display member is rotated to the angle with respect to the base member.
